(19) United States
(12) Patent Application Publication
(10) Pub. No.: US 2026/0187939 A1
(43) Pub. Date: Jul. 2, 2026

(54) EFFICIENT TRANSFER OF AUGMETNED REALITY OBJECTS

(71) Applicant: International Business Machines Corporation, Armonk, NY (US)

(72) Inventors: Charan Acharya Chandrashekar, Bangalore (IN); Nikhil Sai Krishna Jonnavithula, Visakhapatnam (IN); Prasanth Gelli, Vijayawada (IN); Raja Rahul, Visakhapatnam (IN)

(21) Appl. No.: 19/007,645

(22) Filed: Jan. 2, 2025

(51) Int. Cl. G06T 19/00

(52) U.S. Cl. CPC G06T 19/006

(57) ABSTRACT

A computer-implemented method includes generating a list of statically defined augmented reality objects using a central server. A set of features defining at least one augmented reality object of the list of statically defined augmented reality objects is extracted from the at least one augmented reality object using the central server. A list of reusable features from the set of features is generated at the central server. The reusable features are transmitted from the central server to at least one client device. A unique identifier (ID) is assigned to each reusable feature of the list of reusable features and a registry is created correlating each reusable feature to the assigned unique ID. An instruction file is provided from the central server to the client device. The instruction file defines an augmented reality (AR) object by defining a set of unique IDs and parameters defining each unique ID.

### BACKGROUND

The present invention generally relates to augmented reality systems, and more particularly to a system for efficiently transferring augmented reality objects to a display.

Augmented reality (AR) is a technology that superimposes digital content such as images, sounds, and videos onto the real world. The digital content enables users to simultaneously interact with both the physical and virtual environments.

### SUMMARY

Embodiments of the present invention are directed to a computer-implemented method for efficiently transferring augmented reality objects to a display. A non-limiting example of the computer-implemented method includes generating a list of statically defined augmented reality objects using a central server. A set of features defining at least one augmented reality object of the list of statically defined augmented reality objects is extracted from the at least one augmented reality object using the central server. A list of reusable features from the set of features is generated at the central server. The reusable features are transmitted from the central server to at least one client device. A unique identifier (ID) is assigned to each reusable feature of the list of reusable features and a registry is created correlating each reusable feature to the assigned unique ID. An instruction file is provided from the central server to the client device. The instruction file defines an augmented reality (AR) object by defining a set of unique IDs and parameters defining each unique ID.

Embodiments of the present invention are similarly directed to a system and a computer program product for efficiently transferring augmented reality objects to a display according to the computer-implemented method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 depicts an augmented reality object superimposed over a real world view;

FIGS. 3A, 3B and 3C depict variations of the augmented reality object of FIG. 2, with the variations depending on real world context;

FIG. 4 depicts a process for efficiently transferring the augmented reality object from a central server to a display when the object is made up of static content;

FIG. 5 depicts a process for efficiently transferring the augmented reality object from a central server to a display when the object is made up of dynamic content; and

FIG. 6 depicts a communication architecture for implementing the processes of FIGS. 4 and 5.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as an efficient transfer of augmented reality objects at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 141, host physical machine set 142, virtual machine set 143, and container set 144.

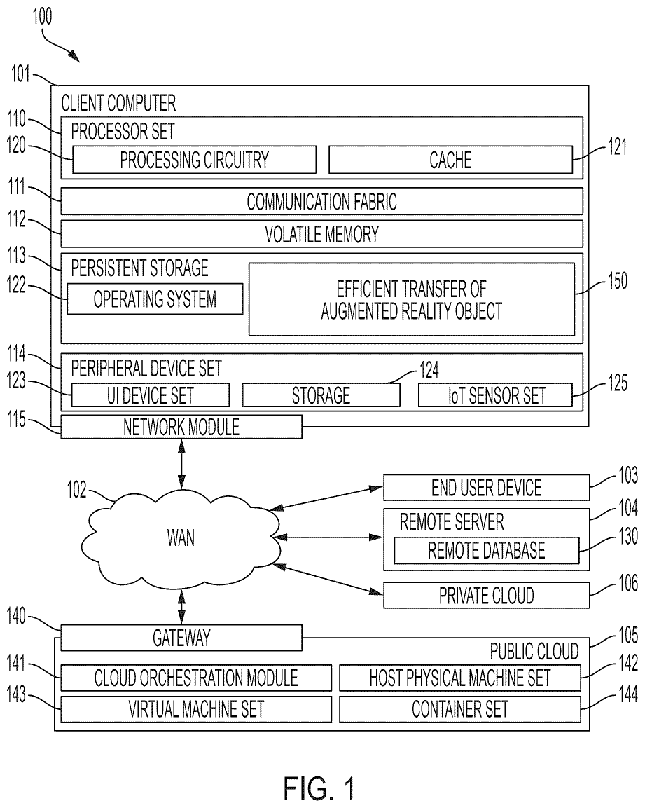

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 141. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, industrial AR solutions provide a good way to create and deliver consumable work instructions, procedures, and critical information to workers by overlaying the content onto a real-world work environment using display devices. This connects employees and can improve business outcomes.

Augmented reality can further assist with work force training, manufacturing and product assembly, repair and maintenance processes, remote assistance, quality assurance operations and any similar business activities. In some cases, the assistance can take the form of step-by-step instructions regarding how to perform current or next steps.

In current AR systems, three dimensional models of AR objects are rendered to client devices (e.g. display screens) from a centralized server. Based on the viewing angle and motion of the display screen, the centralized server determines the three dimensional model relevant to the user's field of view and renders the determined three dimensional object as an AR object to be displayed to the user. In most cases, the AR object is then provided to the user's display via the internet and/or similar large area computer networks. Providing the AR object(s) to the users requires high transfer speeds and bandwidth in order to ensure that all users are able to receive the appropriate AR object(s) when the AR object(s) are needed.

Furthermore, various aspects of any given three dimensional model including text, signs, background, pictures, and the like are present in the AR object and will vary slightly from rendering to rendering. While some of the aspects of a three dimensional model appear the same, all aspects are re-rendered each time due to changes in overlaying texts, colors of backgrounds, changes in size, changes in orientation, etc.

Continuously re-rendering and retransferring the AR objects utilizes a substantial amount of bandwidth to accommodate the data transfers. When multiple users are simultaneously using AR systems over the same network, the network can quickly be overloaded resulting in degradation of service.

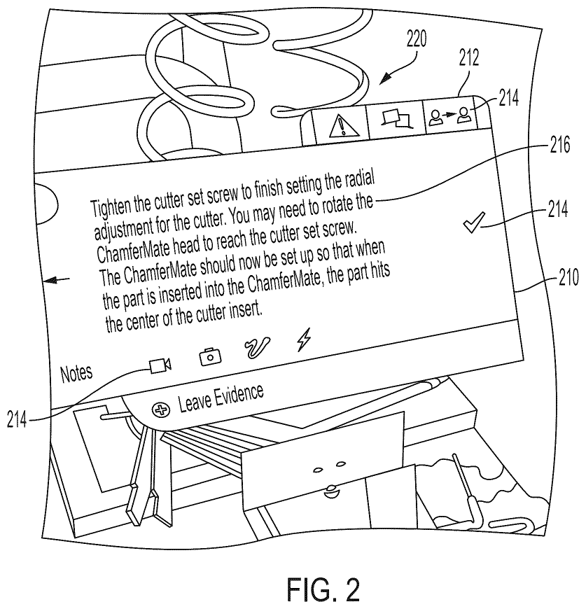

With continued reference to FIG. 1, FIG. 2 illustrates an exemplary AR object 210 superimposed over a real world view 220. The AR object 210 includes numerous distinct features, including tabs 212, icons 214, text boxes 216 and the like (collectively referred to as features 212, 214, 216). Each of the distinct features 212, 214, 216 is defined by positional information relative to the other features 212, 214, 216, content information (e.g., the specific text included within the text box 216), icon 214 layout, opacity, frame size, etc.

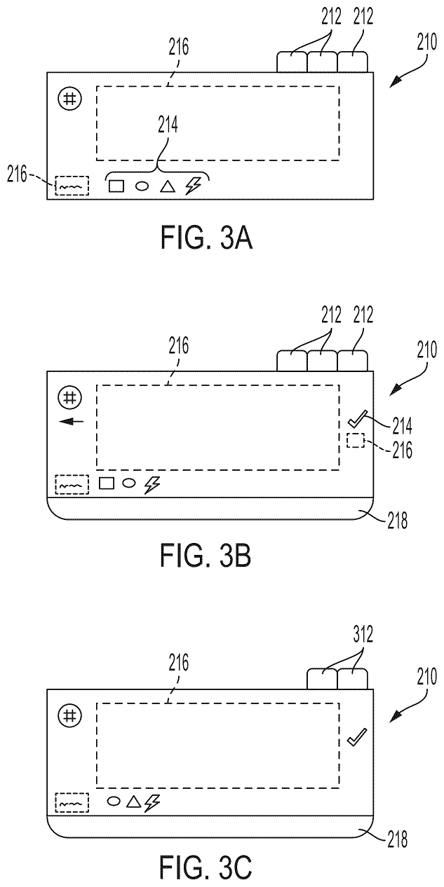

With continued reference to FIG. 2, FIGS. 3A, 3B, and 3C illustrate the same AR object 210, isolated from the real world view 220, in three distinct variations. In the example of FIG. 3A, the AR object 210 includes three tabs 212, three text boxes 216, and a set of icons 214.

In the second variation (FIG. 3B), one of the text boxes 216 is enlarged to provide room for additional text, and each other tab 212, icon 214 and text box 216 should be shifted to accommodate the larger size. One less icon 214 is included at underneath the central text box 216, and an additional icon 214 is included adjacent the central text box 216. An additional pane 218 is added below the central text box 216.

In the third variation (FIG. 3C), on less tab 312 is used, the central text box 216 is reduced in size and the new text box 216 of the second variation (FIG. 3B) is removed.

The example AR object 210, and the illustrated variations of FIGS. 3A, 3B and 3C, are provided as examples to demonstrate a small subset of the variations that may occur within a single AR object 210 requiring the AR object 210 to be rendered in existing AR systems. The particular variations and configuration of the AR objects 210 do not limit the scope, content, or type of AR objects 210 which may be presented in an AR system implementing the processes described herein.

Certain existing AR systems utilize AR caching. In AR caching AR objects (such as AR object 210) are cached within a user device and/or local display system once rendered and transferred. These systems are limited, however, in that the cached objects are locked in with the predefined features and parameters and cannot vary. In the examples of FIGS. 3A, 3B, 3C each variation of the AR object 210 would need to be cached as a separate object, and the full AR object 210 of each variation still needs to be transferred from a central server to display device(s) and cached separately.

Turning now to an overview of the aspects of the invention, one or more embodiments of the invention address the above-described shortcomings of the prior art by providing a system and method that reduces the volume of data transferred to client devices in industrial augmented reality (AR) and similar systems. The process identifies commonly used features of AR objects (e.g., AR object 210) and categorizes the commonly used objects as a set of reusable 3D elements. Within the context of FIGS. 3A, 3B, and 3C, for example a single “text box” element may be defined, a single tab element may be defined, etc.

Once the reusable 3D elements have been defined, they are persisted in the end user device(s), and the central server provides a text instruction to the client devices defining relative positions, sizes, contents, and the like of the elements from which the AR object 210 is constructed and the client device(s) create and display the AR object 210 by overlaying the relevant sets of persisted 3D elements into a single 3D object. In some examples, a single element may be iterated multiple times (e.g., a tab) with different parameters for position, size, content, and the like.

AR objects can typically take one of two forms, static objects where the entire content of the object is available before streaming or being requested by the user, and dynamic content where the AR object is made available in response to a user request.

By way of example, a user manual describing operation of a paper manufacturing machine including various components and processes of the machine is a form of static content, because the user manual and any associated AR objects are statically defined prior to being accessed or used and the content of the AR objects does not change depending on the context.

In contrast, a current battery status of a machine, a process status of an ongoing process, a percentage of coolant remaining in a machine, and the like are represented by dynamic AR objects because the content of the AR object is not predetermined. Instead, at least a portion of the content is generated on the fly. In some examples, where machine learning systems are integrated into the AR process the full dynamic AR object may be generated on the fly. In other examples, portions of the AR object are generated on the fly, while other portions can be predefined. As used herein, “dynamic” refers to an AR object that includes one or more features that is generated as the AR system is operating.

With continued reference to FIGS. 1-3, FIG. 4 illustrates a process 400 for configuring an AR system to provide efficient data usage when transferring static AR objects, such as the AR object 210 of FIGS. 2-3C. Prior to streaming the AR objects, the process 400 generates an exhaustive list of the statically defined objects in a list step 410 at a central server storing the AR objects.

Using the exhaustive list, the central server extracts features from each AR object 210 using any conventional feature extraction process in a feature extraction step 420. In one example, the feature extraction process uses a feature point detection algorithm. The general function of the feature detection is to identify various constituent features of the AR object 210, as well as any characteristics defining the AR object 210. By way of example, the characteristics can include height and width dimensions, a z-position relative to other features, text inclusions, opacity, icon size, icon type, etc. Depending on the particular AR system operating the process 400 the characteristics may include all of these, a subset of these, or more of these and still fall within the scope of this disclosure.

In one example of the feature extraction step 420, the feature extraction algorithm is applied to extract distinct key points from the AR object. Then, a segmentation algorithm, such as a region growing algorithm, is applied to extract a background from the AR object. This process is iterated again with the inclusion of a shape analysis that extracts text from the AR object. In some cases, further verification processes and refinement process (e.g. manual review of a subset of features) is performed on the extracted features.

Once extracted, the features are separated by classification in a separate features step 430. In one example, the classification is based on type. By way of example the features may be separated into structures (e.g. three dimensional constructs) and backgrounds 432, texts or tutorial features 434 and images or icons 436. In alternative examples, any other classification may be utilized to achieve similar separation of features.

After separating the features, the process 400 generates a shortlist of frequently occurring features in a generate shortlist step 440. The shortlist of frequently occurring features is a list of the most re-usable features from which the AR objects are constructed. In one example, the shortlist is the N most common features across all the objects identified at step 410. In another example, the shortlist is a combination of features which are used to construct the N most commonly used AR objects. In another example, the shortlist is the top N features whose combination could construct a majority of the AR objects. At a conclusion of the generate shortlist step 430, the features defined on the generated shortlist are provided to a client side storage (e.g. a memory within a display device) and persisted at the client side storage.

By way of example, the shortlisted features may be provided to an internal memory of a wearable vision system including a headset and a screen, or to any similar local augmented reality system including screens, tablets, wearable augmented reality systems, and the like.

The client side AR device assigns a unique ID to each of the features that is short listed and indexes the shortlisted features within a registry in an assign unique identity step 450. Once assigned the registry is provided to the central server in an update registry step 460. The central server then defines AR objects using a text file that identifies each feature based on the corresponding unique ID and any associated parameter(s). The AR device constructs AR objects based on text instructions received from the central server in a client polling and persist objects step 470. In alternate examples, the text file may be replaced with an encrypted file, a binary file, a string of instructions, or any similar file or set of files able to communicate the unique ID's and the associated parameters from which the AR object is constructed. As used herein, such a file is referred to as an instruction file, and is of a substantially smaller data size than a full AR object file.

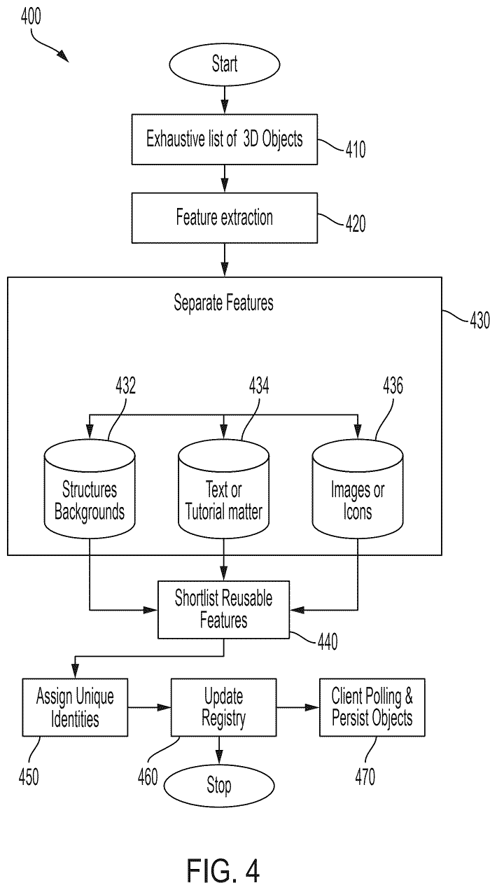

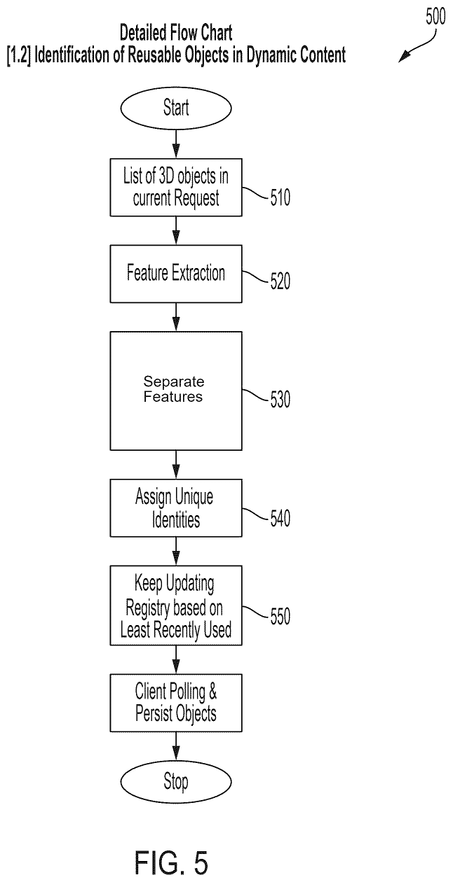

With continued reference to FIG. 4, FIG. 5 illustrates a process 500 for configuring an AR system to provide efficient data usage when transferring dynamic AR objects. The process 500 of FIG. 5 initially operates in the same manner as the process 400 of FIG. 4, with steps 510, 520, 530 operating identically to the corresponding steps 410, 420, 430, with the exception of feature extraction step 520 being performed on a single AR object, rather than being performed across a set of all AR objects as in the feature extraction step 420.

Unlike the static example of FIG. 4, the short list of features is not generated by ranking all the features. Since type of request is dynamic, analysis of best features to persist locally on the client by comparing at a global-bucket of all possible features is not available. Instead, particular types of features are directly shortlisted. By way of example, a feature that falls within a background or a sign category may be shortlisted, while other features, such as text, are ignored. The shortlisted features are then assigned IDs on the server-side in an assign unique identities step 540.

Throughout operation of the process 500, a server side registry is maintained in a maintain registry step 550. The registry has a standard buffer size. The buffer size dictates a maximum number of features that can be stored in the registry. An algorithm is applied to remove infrequently used features from the registry. Similarly, an algorithm is used to add frequently used features that are not currently on the registry to the registry. This type of algorithm is referred to as a least recently used (LRU) algorithm. The registry can be maintained in any memory, and may be accessed by both the AR device on the client side and the server. In alternative examples, alternative types of algorithms may be utilized to maintain the registry. As with the process 400 (illustrated in FIG. 4) for static AR objects, the AR device constructs AR objects based on text instructions defining the features of the AR object in a client polling and persist objects step 470.

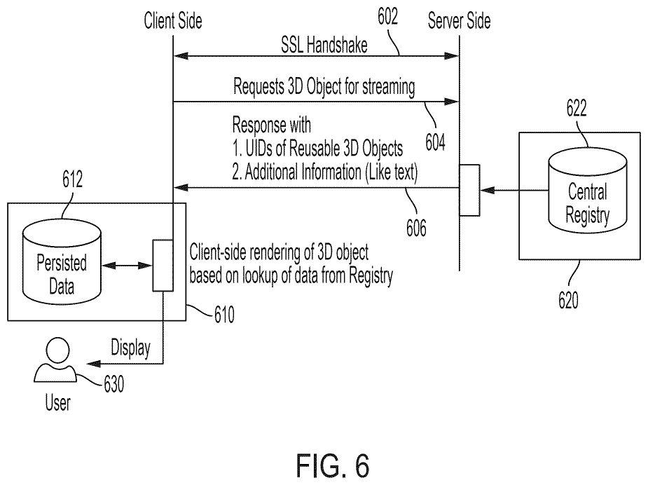

With continued reference to FIGS. 1-5, FIG. 6 illustrates a communication architecture for implementing the processes of FIGS. 4 and 5, using a client side AR device 610 storing locally persisted features 612, in communication with a central server 620 containing the central registry of features 622. Initially the AR device 610 establishes communication with the server 620 using any conventional protocol 602. By way of example, the communication may be established using an SSL handshake protocol.

Once communication has been established, the AR device 610 sends a request 604 for an AR object to display to a user 630. The server 620 identifies the AR object, using the registry 622 and responds 606 with unique IDs of each constituent feature used to construct the AR object as well as any additional defining information, such as features sizes, relative positioning of the features, text for inclusion in text boxes, etc. In some examples, the full response is an instruction file formatted as a text file.

The client AR device 610 receives the response and constructs the AR object using the persisted data 612. In some examples, the response may also include a full implementation of one or more features that are not within the persisted data 612.

By defining. the AR object using the persisted data in the manner described and illustrated herein, the size of the communications between the client device 610 and the server 620 can be significantly reduced relative to existing systems, thereby providing substantial improvements to data transfer, speed, and operability under bandwidth limitations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating a list of statically defined augmented reality objects using a central server;
extracting a set of features defining at least one augmented reality object of the list of statically defined augmented reality objects using the central server;
generating a list of reusable features from the set of features at the central server;
transmitting the reusable features from the central server to at least one client device;
assigning a unique identifier (ID) to each reusable feature of the list of reusable features and creating a registry correlating each reusable feature to the assigned unique ID; and
providing an instruction file from the central server to the client device, wherein the instruction file defines an augmented reality (AR) object by defining a set of unique IDs and parameters defining each unique ID.

2. The computer-implemented method of claim 1, further comprising constructing the AR object using the at least one client device and displaying the AR object to a user of the at least one client device.

3. The computer-implemented method of claim 1, further comprising separating the set of features into a plurality of subsets based on at least one feature type classification.

4. The computer-implemented method of claim 1, wherein extracting the set of features defining at least one augmented reality object comprises extracting features defining all augmented reality objects on the list of statically defined augmented reality objects.

5. The computer-implemented method of claim 4, wherein generating the list of reusable features from the set of features at the central server comprises generating a list of most common features across the augmented reality objects in the list of statically defined augmented reality objects.

6. The computer-implemented method of claim 4, wherein generating the list of reusable features from the set of features at the central server comprises generating a list of features used to construct a set of most commonly used augmented reality objects in the list of statically defined augmented reality objects.

7. The computer-implemented method of claim 4, wherein generating the list of reusable features from the set of features at the central server comprises generating a list of features whose combination could construct a majority of augmented reality objects in the list of statically defined augmented reality objects.

8. The computer-implemented method of claim 1, wherein generating the list of reusable features from the set of features at the central server comprises generating a list of features of a single augmented reality object in the list of statically defined augmented reality objects.

9. The computer-implemented method of claim 1, wherein the augmented reality (AR) object defined by the set of unique IDs is a dynamic AR object, and wherein the registry correlating each reusable feature to the assigned unique ID is continuously updated according to a least recently used (LRU) algorithm.

10. An augmented reality system comprising:
a central server in communication with at least one augmented reality display, wherein the augmented reality system is configured to:
generate a list of statically defined augmented reality objects using the central server;
extract a set of features defining at least one augmented reality object of the list of statically defined augmented reality objects using the central server;
generate a list of reusable features from the set of features at the central server;
transmit the reusable features from the central server to the at least one augmented reality display;
assigning a unique identifier (ID) to each reusable feature of the list of reusable features and creating a registry correlating each reusable feature to the assigned unique ID; and
providing an instruction file from the central server to a client device, wherein the instruction file defines an augmented reality (AR) object by defining a set of unique IDs and parameters defining each unique ID.

11. The system of claim 10, further comprising constructing the AR object using the client device and displaying the AR object to a user of the client device.

12. The system of claim 10, further comprising separating the set of features into a plurality of subsets based on at least one feature type classification.

13. The system of claim 10, wherein extracting the set of features defining at least one augmented reality object comprises extracting features defining all augmented reality objects on the list of statically defined augmented reality objects.

14. The system of claim 13, wherein generating the list of reusable features from the set of features at the central server comprises generating a list of most common features across the augmented reality objects in the list of statically defined augmented reality objects.

15. The system of claim 13, wherein generating the list of reusable features from the set of features at the central server comprises generating a list of features used to construct a set of most commonly used augmented reality objects in the list of statically defined augmented reality objects.

16. The system of claim 13, wherein generating the list of reusable features from the set of features at the central server comprises generating a list of features whose combination could construct a majority of augmented reality objects in the list of statically defined augmented reality objects.

17. The system of claim 10, wherein generating the list of reusable features from the set of features at the central server comprises generating a list of features of a single augmented reality object in the list of statically defined augmented reality objects.

18. The system of claim 10, wherein the augmented reality (AR) object defined by the set of unique IDs is a dynamic AR object, and wherein the registry correlating each reusable feature to the assigned unique ID is continuously updated according to a least recently used (LRU) algorithm.

19. A computer program product comprising:
a non-transitory computer-readable medium storing instructions for causing a computer system to implement an augmented reality system including:
generating a list of statically defined augmented reality objects using a central server;
extracting a set of features defining at least one augmented reality object of the list of statically defined augmented reality objects using the central server;
generating a list of reusable features from the set of features at the central server;
transmitting the reusable features from the central server to at least one client device;
assigning a unique identifier (ID) to each reusable feature of the list of reusable features and creating a registry correlating each reusable feature to the assigned unique ID; and
providing an instruction file from the central server to the client device, wherein the instruction file defines an augmented reality (AR) object by defining a set of unique IDs and parameters defining each unique ID.

20. The computer program product of claim 19, wherein the computer-readable medium further stores instructions for causing the at least one client device to construct the AR object using and display the AR object to a user of the at least one client device.
